(19) United States
(12) Patent Application Publication
(10) Pub. No.: US 2011/0173610 A1
(43) Pub. Date: Jul. 14, 2011

(54) VIRTUAL MACHINE, REMOTE START METHOD, AND VIRTUAL MACHINE SYSTEM

(75) Inventor: Kenichirou SHIMOGAWA, Kawasaki (JP)

(73) Assignee: FUJITSU LIMITED, Kawasaki-shi (JP)

(21) Appl. No.: 12/984,689

(22) Filed: Jan. 5, 2011

(30) Foreign Application Priority Data
Jan. 12, 2010 (JP) 2010-004409

(51) Int. Cl. G06F 9/455

(52) U.S. Cl. 718/1

(57) ABSTRACT

A virtual machine includes an identification information producing unit that produces identification information when a production request for new identification information used for starting a guest operating system (OS) controlled by a host OS is obtained via a network, an identification information storing unit that stores the produced identification information in association with the guest OS that starts by using the identification information, and a guest OS starting unit that, when a start request for starting the guest OS using the identification information is obtained via the network during an off state of the guest OS, compares the obtained identification information with the identification information stored in the identification information storing unit and starts the guest OS for which the start request is made through the host OS based on the comparison result.

### CROSS-REFERENCE TO RELATED APPLICATION

This application is based upon and claims the benefit of priority of the prior Japanese Patent Application No. 2010-004409, filed on Jan. 12, 2010, the entire contents of which are incorporated herein by reference.

### FIELD

The embodiments discussed herein are directed to a virtual machine, a remote machine system, and a remote start method.

### BACKGROUND

As a conventional function for remotely controlling a personal computer (PC) or a server, there is a wake on local area network (WOL) (see Japanese Laid-open Patent Publication No. 2004-171412 and Japanese Laid-open Patent Publication No. 2005-20728). The WOL is a technique for, when a computer connected to a LAN is powered off, powering up the powered-off computer from another computer connected to the same LAN. By using the WOL, for example, when performing maintenance of computers all together at night or on holidays a network administrator can power up computers at remote sites by operating a computer near himself/herself without visiting job sites.

In order to implement the WOL, a LAN card, a motherboard, a basic input/output system (BIOS), and an operating system (OS) of a computer that is to be started should support the WOL.

A mechanism of the WOL in an actual machine environment of a client-server system will be explained with reference to FIG. 13 (see http://itpro.nikkeibp.co.jp/article/Keyword/20070222/262829/ITpro, 2006.09.15). FIG. 13 is a diagram for explaining a WOL of an actual machine environment. As illustrated in FIG. 13, a WOL client remotely controls the power on of a powered-off PC that is a management target. Specifically, the WOL client transmits a WOL packet (a magic packet) that includes 16 consecutive media access control (MAC) addresses of the powered-off management target PC. A LAN adapter (a LAN card) that supports the WOL recognizes the magic packet and powers up the management target PC corresponding to the MAC address included in the magic packet.

An actual machine environment in which a plurality of different nodes is divided with two or more sections has been suggested. In such an actual machine environment, partition management software constitutes a WOL filter of each network interface card (NIC) included in the node within the section. The partition management software recognizes the magic packet directed toward the NIC and powers up the node on the NIC.

In recent years, a virtual machine which allows a plurality of OSs to operate in a single computer has attracted public attention. In the virtual machine, a host OS that initially starts to operate when the computer is powered up and a guest OS that operates on the host OS can simultaneously operate.

When applying the WOL to the virtual machine, the host OS usually starts to operate when the computer is powered up. Then, the host OS powers up the guest OS. A mechanism of the WOL in a virtual machine environment will be explained with reference to FIG. 14. FIG. 14 is a view for explaining a WOL of a virtual machine environment. As illustrated in FIG. 14, for example, an administrator PC remotely controls the power on of a powered-off guest OS. Specifically, the administrator PC logs in the host OS. When the administrator PC successfully logs in the host OS, the administrator PC instructs the host OS to power up the powered-off guest OS. The host OS powers up the instructed guest OS.

However, the conventional WOL technique in the virtual machine environment has a problem in that a third party can illegally start the guest OS included in the virtual machine via a network. That is, if a remote control operator such as a network administrator can operate the administrator PC and log in the host OS, he/she can gain access to the entire guest OSs through the host OS. For this reason, if a user name and a password that are required for logging in the host OS are leaked, a third party that knows the user name and the password can log in the host OS and illegally start the guest OS via the network.

### SUMMARY

According to an aspect of an embodiment of the invention, a virtual machine includes an identification information producing unit that produces identification information when a production request for new identification information used for starting a guest operating system (OS) controlled by a host OS is received via a network; an identification information storing unit that stores the identification information produced by the identification information producing unit in association with a guest OS that starts by using the identification information; and a guest OS starting unit that, when a start request for starting the guest OS using the identification information is received via the network during an off state of the guest OS, compares the produced identification information with the identification information stored in the identification information storing unit and starts the guest OS for which the start request is made through the host OS based on the comparison result.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram illustrating a structure of a virtual machine according to a first embodiment;

FIGS. 2A and 2B is a diagram illustrating the whole structure of the virtual machine;

FIG. 2B is a diagram illustrating an execution of an input/output process;

FIG. 3 is a functional block diagram illustrating a structure of a virtual machine system according to a second embodiment;

FIG. 4 illustrates an example of a data structure of a magic packet key management storage unit;

FIG. 5 illustrates an example of a data structure of a magic packet key storing unit;

FIG. 6 is a flowchart illustrating an operation of a magic packet key producing process;

FIG. 7 is a flowchart illustrating an operation of a guest OS start process;

FIG. 8 is a sequence diagram illustrating an operation of the virtual machine system according to the second embodiment;

FIG. 9 is a functional block diagram illustrating a structure of a virtual machine system according to a third embodiment;

FIG. 10 is a flowchart illustrating an operation of a guest OS start process;

FIG. 11 is a sequence diagram illustrating an operation of the virtual machine system according to the third embodiment;

FIG. 12 is a diagram illustrating a computer that executes a remote start program;

FIG. 13 is a diagram illustrating a wake-on local area network (WOL) of an actual machine environment; and

FIG. 14 is a diagram illustrating a WOL of a virtual machine environment.

### DESCRIPTION OF EMBODIMENTS

Preferred embodiments of the present invention will be explained with reference to accompanying drawings. The present invention is not limited to the embodiments.

### [a] First Embodiment

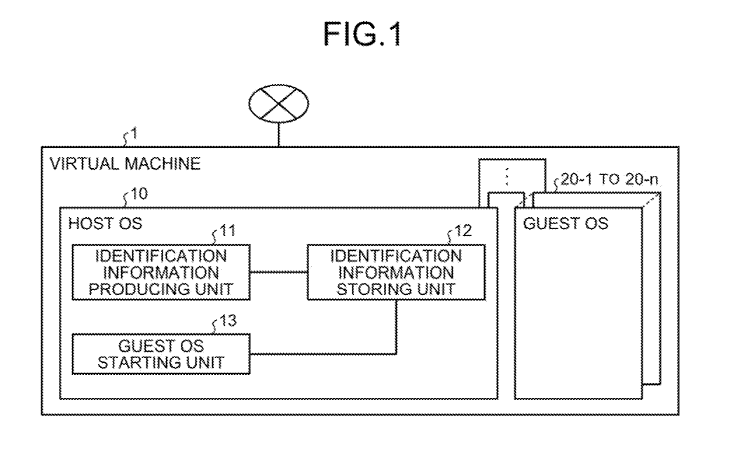

FIG. 1 is a functional block diagram illustrating a structure of a virtual machine according to a first embodiment. As illustrated in FIG. 1, a virtual machine 1 is connected to a network and includes a host OS 10 and guest OSs 20-1 to 20-n. The host OS 10 includes an identification information producing unit 11, an identification information storing unit 12, and a guest OS starting unit 13.

The start of the guest OSs 20-1 to 20-n is controlled by the host OS 10. The identification information producing unit 11 produces identification information when a production request for new identification information used for starting the guest OSs 20-1 to 20-n is received via the network.

The identification information storing unit 12 stores the identification information produced by the identification information producing unit 11 in association with the guest OS that is to be started using the identification information. The guest OS starting unit 13 receives a start request for starting the guest OS using the identification information via the network when the guest OS is in an OFF state. In this case, the guest OS starting unit 13 compares the identification information with use of the identification information stored in the identification information storing unit 12 and starts the guest OS for which the start request is made through the host OS 10 based on the comparison result.

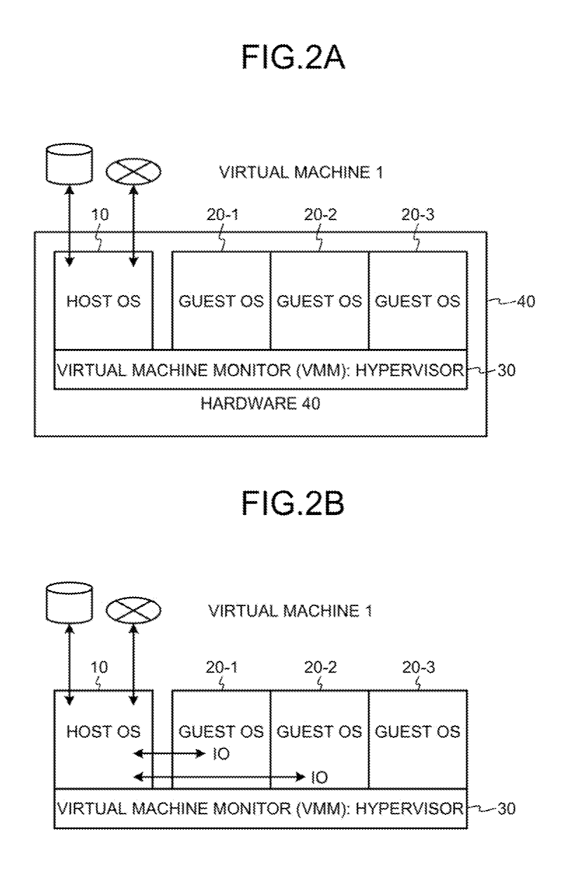

The whole structure of the virtual machine 1 including the host OS 10 and the guest OSs 20-1 to 20-n (for example, n is “3”) will be explained with reference to FIGS. 2A and 2B. FIG. 2A illustrates the whole structure of the virtual machine 1, and FIG. 2B is a diagram illustrating an execution of an input/output (IO) process. As illustrated in FIG. 2A, the virtual machine 1 further includes a hypervisor 30 and hardware 40 in addition to the host OS 10 and the guest OSs 20-1 to 20-n.

The host OS 10 is fundamental software that is the basis of the operation of the virtual machine 1 and controls both starts and stops of the guest OSs 20-1 to 20-n. The host OS 10 allocates resources such as a central processing unit (CPU), a memory, and an IO to the guest OSs 20-1 to 20-n. The host OS 10 performs a virtual IO process executed by the guest OSs 20-1 to 20-n and reflects the process results of the virtual IO process in a mounted IO device. For example, as illustrated in FIG. 2B, the host OS 10 stores the process result of the virtual IO process executed by the guest OSs 20-1 to 20-n in a hard disk drive (HDD). Further, the host OS 10 transmits the process result of the virtual IO process executed by the guest OSs 20-1 to 20-n to the network.

The guest OSs 20-1 to 20-n are fundamental software, similarly to the host OS 10 and enables an operation of an application program that does not operate on the host OS 10. The guest OSs 20-1 to 20-n virtually execute the IO process using the resources allocated by the host OS 10 and feed the process result of the IO process into the IO device through the host OS 10. The guest OSs 20-1 to 20-n are started by the host OS 10 when they are in the OFF state.

The hypervisor 30 virtualizes the hardware 40 so that the host OS 10 and the guest OSs 20-1 to 20-n can utilize the hardware 40 of the computer. The host OS 10 and the guest OSs 20-1 to 20-n operate on the hypervisor 30. When electric power is supplied to the virtual machine 1, the hypervisor 30 initially operates and starts the host OS 10.

The hardware 40 represents, for example, a LAN card connected to the network and is controlled by a BIOS that provides a basic IO environment of peripherals including the LAN card.

When the production request for new identification information used for starting the guest OS 20-1 is received via the network, the hardware 40 transmits the production request to the identification information producing unit 11 through the hypervisor 30. The identification information producing unit 11 produces new identification information used for starting the guest OS 20-1. The identification information storing unit 12 stores the identification information produced by the identification information producing unit 11 in association with the guest OS 20-1 that is to be started using the identification information. Further, when the guest OS 20-1 is in the OFF state, if the start request for starting the guest OS 20-1 using the identification information is received from the network, the hardware 40 transmits the start request to the guest OS starting unit 13 through the hypervisor 30. The guest OS starting unit 13 compares the received identification information with the identification information stored in the identification information storing unit 12 and starts the guest OS 20-1 for which the start request is made based on the comparison result.

As described above, the virtual machine 1 produces new identification information every time when the production request for the identification information used for starting the guest OS is made and stores new identification information produced by the latest production request in association with the corresponding guest OS. Therefore, when the start request for starting the guest OS using the identification information is made via the network, the virtual machine 1 can verify the validity of the identification information used at the time when the start request is made with the latest new identification information associated with the guest OS. As a result, the virtual machine 1 can surely prevent the guest OS from being illegally started and make the start of the guest OS secure. That is, the virtual machine 1 can prevent the guest OS from being started by using leaked identification information when the identification information used at the time of the start request of the guest OS is leaked.

### [b] Second Embodiment

Structure of a Virtual Machine According to Second Embodiment

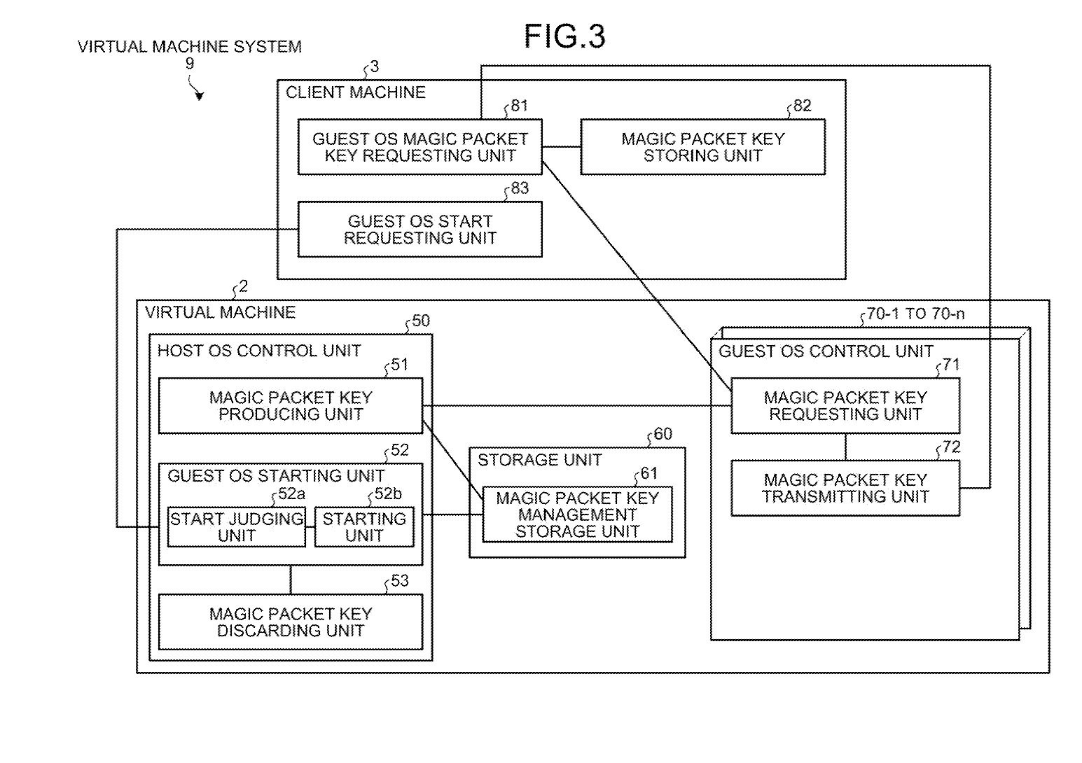

FIG. 3 is a functional block diagram illustrating a structure of a virtual machine system 9 using a virtual machine 2 according to a second embodiment. The virtual machine system 9 includes the virtual machine 2 and a client machine 3. The virtual machine 2 includes a host OS control unit 50 that controls the host OS and the guest OS, a storage unit 60, and guest OS control units 70-1 to 70-n that control corresponding guest OSs, respectively. The host OS control unit 50 includes a magic packet key producing unit 51, a guest OS starting unit 52, and a magic packet key discarding unit 53. The storage unit 60 includes a magic packet key management storage unit 61. The guest OS control units 70-1 to 70-n are disposed in guest OSs different from each other, respectively, and each of the guest OS control units 70-1 to 70-n includes a magic packet key requesting unit 71 and a magic packet key transmitting unit 72.

The host OS control unit 50 and the guest OS control units 70-1 to 70-n are integrated circuits (ICs) such as an application specific integrated circuit (ASIC) or a field programmable gate array (FPGA). The host OS control unit 50 and the guest OS control units 70-1 to 70-n are not limited thereto and may be electronic circuits such as a CPU or a micro processing unit (MPU). The storage unit 60 is a semiconductor memory device such as a random access memory (RAM) or a flash memory or a storage device such as a HDD or an optical disk.

The magic packet key producing unit 51 produces identification information when the production request for new identification information used for starting any one of the guest OSs is received via the network. Specifically, when the production request for new identification information is received from the magic packet key requesting unit 71 of one of the guest OS control units 70-1 to 70-n is received, the magic packet key producing unit 51 produces the identification information associated with the guest OS.

For example, the magic packet key producing unit 51 produces the identification information associated with each guest OS using a universally unique identifier (UUID). The magic packet key producing unit 51 may produce the identification information in the same format as the MAC address. Specifically, the magic packet key producing unit 51 produces the identification information in the form of a character string in which 12 hexadecimal character are continued like “0×AABBCCDDEEFF”, similarly to the MAC address. The example in which the magic packet key producing unit 51 produces the identification information using the UUID has been explained, but the present invention is not limited thereto, and identification information determined uniquely for each guest OS may be used. In the present embodiments, the “magic packet key” is used as the identification information.

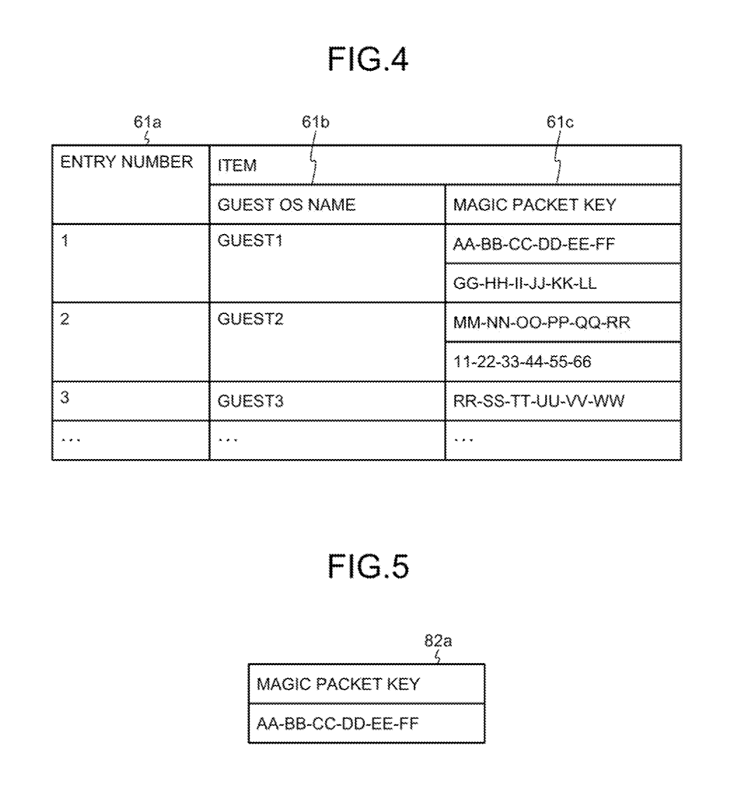

The magic packet key producing unit 51 stores the produced magic packet key in the magic packet key management storage unit 61 in association with the guest OS that starts by using the magic packet key. The magic packet key management storage unit 61 will be explained with reference to FIG. 4. FIG. 4 is a view illustrating an example of a data structure of data stored in the magic packet key management storage unit 61. As illustrated in FIG. 4, the magic packet key management storage unit 61 stores an entry number 61a, a guest OS name 61b, and a magic packet key 61c in association with each of a plurality of guest OSs.

The entry number 61a is a number uniquely associated with the guest OS, and, for example, the number is given in ascending order sequentially starting from “1”. The guest OS name 61b is an identifier predetermined for the guest OS. The magic packet key 61c is a magic packet key associated with the guest OS name 61b. The magic packet key 61c may be associated with the guest OS name 61b in a one to one correspondence relationship. That is, when a plurality of client machines 3 start the same guest OS, the magic packet key 61c used by each of the client machines 3 may be uniquely associated with the guest OS.

The magic packet key 61c may be associated with the guest OS name 61b in a one to n correspondence relationship (n>1). That is, when a plurality of client machines 3 starts the same guest OS, the magic packet key 61c used by each of the client machines 3 may be associated with the corresponding guest OS for each of the client machines 3. For example, in the example of FIG. 4, the magic packet key 61c is associated with the guest OS name “Guest1” for each of the client machines 3. One is “AA-BB-CC-DD-EE-FF” and another is “GG-HH-II-JJ-KK-LL”. As described above, the magic packet key 61c may have the same format as the MAC address.

Referring again to FIG. 3, the magic packet key producing unit 51 transmits the produced magic packet key to the guest OS control units 70-1 to 70-n of request sources of the magic packet key.

The guest OS starting unit 52 receives the start request for starting the corresponding guest OS using the magic packet key via the network when the guest OS is in the OFF state. In this case, the guest OS starting unit 52 compares the magic packet key with the magic packet key 61c stored in the magic packet key management storage unit 61 and starts the guest OS for which the start request is made through the host OS based on the comparison result. The guest OS starting unit 52 includes a start judging unit 52a and a starting unit 52b.

When the guest OS is in an OFF state, if the start request for starting the guest OS using the magic packet key is received from the client machine 3 via the network, the start judging unit 52a judges whether to start the guest OS associated with the magic packet key. Specifically, when the start request including the magic packet key added thereto as the start request of the guest OS is received from a guest OS start requesting unit 83, the start judging unit 52a extracts the added magic packet key from the received start request. The start judging unit 52a compares the extracted magic packet key with the magic packet key 61c stored in the magic packet key management storage unit 61. When the magic packet key matches one of the magic packet keys 61c stored in the magic packet key management storage unit 61, the start judging unit 52a judges to start the guest OS associated with the matched magic packet key. The start judging unit 52a judges not to start the guest OS when the magic packet key does not match any of the magic packet keys 61c stored in the magic packet key management storage unit 61.

The starting unit 52b judges to start the guest OS and starts the guest OS in the OFF state when the guest OS is in the OFF state. The starting unit 52b transmits the start result after starting the guest OS to the client machine 3 that is a request source of the start request for starting the guest OS.

The magic packet key discarding unit 53 discards the magic packet key from the magic packet key management storage unit 61 when the guest OS started using the magic packet key stored in the magic packet key management storage unit 61. For example, when the magic packet key is used once the magic packet key discarding unit 53 judges the magic packet key as an “invalid key”. That is, when the starting unit 52b starts the guest OS using the magic packet key, the magic packet key discarding unit 53 judges the magic packet key as the “invalid key”. The magic packet key discarding unit 53 removes the magic packet key from the magic packet key management storage unit 61. In the above description, the magic packet key discarding unit 53 judges the magic packet key as the “invalid key” when the magic packet key is used once, but the present invention is not limited thereto. For example, the magic packet key discarding unit 53 may judge the magic packet key as the “invalid key” when the same magic packet key is used in a given number of times. Further, when an expiry date or the term of validity for each magic packet key has passed or expired, the magic packet key discarding unit 53 may judge the magic packet key as the “invalid key”.

The magic packet key requesting unit 71 receives a production request for a new magic packet key used for starting its own guest OS from the client machine 3 via the network. The magic packet key requesting unit 71 outputs the production request for the magic packet key to the magic packet key producing unit 51. The magic packet key requesting unit 71 receives the produced new magic packet key from the magic packet key producing unit 51.

The magic packet key transmitting unit 72 transmits the new magic packet key received from the magic packet key requesting unit 71 to a guest OS magic packet key requesting unit 81 that is the origin of the request for the magic packet key.

The guest OS magic packet key requesting unit 81 outputs the production request for the new magic packet key used for starting the guest OS to the magic packet key requesting unit 71 of the virtual machine 2 having the guest OS via the network. The guest OS magic packet key requesting unit 81 receives the new magic packet key from the magic packet key requesting unit 71 and stores the received new magic packet key in a magic packet key storing unit 82.

The magic packet key storing unit 82 will be explained with reference to FIG. 5. FIG. 5 is a view illustrating an example of a data structure of data stored in the magic packet key storing unit 82. As illustrated in FIG. 5, the magic packet key storing unit 82 stores a magic packet key 82a. The magic packet key 82a is a magic packet key associated with the guest OS that is started by the client machine 3. For example, in the example of FIG. 5, the magic packet key 82a associated with the guest OS is “AA-BB-CC-DD-EE-FF”.

The guest OS start requesting unit 83 outputs the start request for starting the guest OS using the magic packet key stored in the magic packet key storing unit 82 to the guest OS starting unit 52 via the network when the guest OS is in the OFF state. The guest OS start requesting unit 83 receives the start result of the guest OS from the guest OS starting unit 52. The guest OS start requesting unit 83 judges whether or not the guest OS was successfully started based on the received start result.

Operation of Magic Packet Key Producing Process According to Second Embodiment

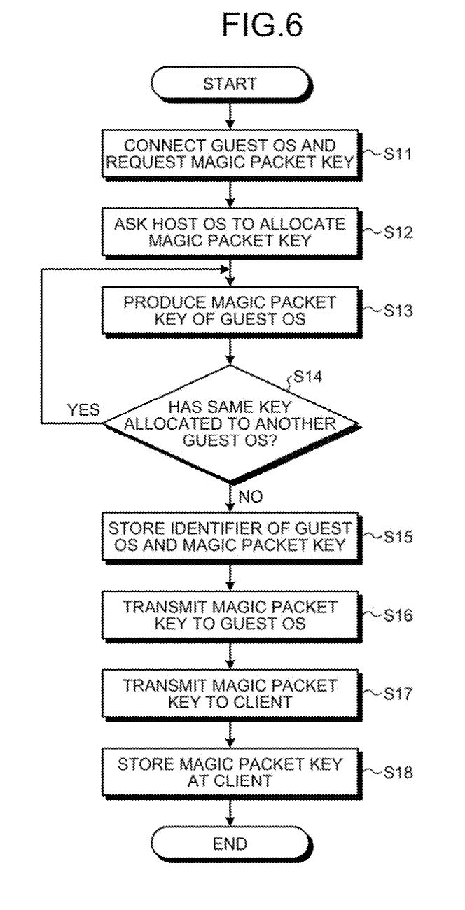

Next, a magic packet key producing process according to the second embodiment will be explained with reference to FIG. 6. FIG. 6 is a flowchart illustrating an operation of a magic packet key producing process. In the flowchart explained below, Step S11 and Step S18 are operations performed by the client machine 3. Step S12 and Step S17 are operations performed by the guest OS control units 70-1 to 70-n. Step S13 to Step S16 are operations performed by the host OS control unit 50. The operations will be explained in connection with an example in which the magic packet key of the guest OS having the guest OS control unit 70-1 is produced.

First, the guest OS magic packet key requesting unit 81 of the client machine 3 is connected to the guest OS having the guest OS control unit 70-1. In Step S11, the guest OS magic packet key requesting unit 81 transmits the production request for a new magic packet key used for starting the connected guest OS to the magic packet key requesting unit 71 of the guest OS via the network.

Subsequently, in Step S12, the magic packet key requesting unit 71 receives the production request for the new magic packet key from the guest OS magic packet key requesting unit 81 via the network and transmits an allocation request of the new magic packet key to the magic packet key producing unit 51.

Then, in Step S13, the magic packet key producing unit 51 of the host OS control unit 50 receives the allocation request with respect to the new magic packet key from the magic packet key requesting unit 71 and produces the new magic packet key associated with the guest OS of the request source.

In Step S14, the magic packet key producing unit 51 judges whether or not the produced magic packet key was already allocated to the magic packet key of another guest OSs. When it is determined that the magic packet key was allocated to the magic packet key of another guest OSs (Yes in Step S14) the process proceeds to Step S13 to produce the magic packet key again.

However, when it is determined that the magic packet key was not allocated to the magic packet key of another guest OSs (No in Step S14), in Step S15 the magic packet key is stored in the magic packet key management storage unit 61 in association with the guest OS for which the allocation request with respect to the magic packet key was made.

In Step S16, the magic packet key producing unit 51 transmits the produced magic packet key to the guest OS control unit 70-1 of the request source.

Subsequently, in Step S17, the magic packet key transmitting unit 72 of the guest OS control unit 70-1 transmits the new magic packet key produced by the magic packet key producing unit 51 to the guest OS magic packet key requesting unit 81 that is the request source of the production request for the magic packet key.

Subsequently, in Step S18, the guest OS magic packet key requesting unit 81 of the client machine 3 receives the magic packet key from the magic packet key requesting unit 71 and stores the magic packet key in the magic packet key storing unit 82.

### Operation of Guest OS Start Process According to Second Embodiment

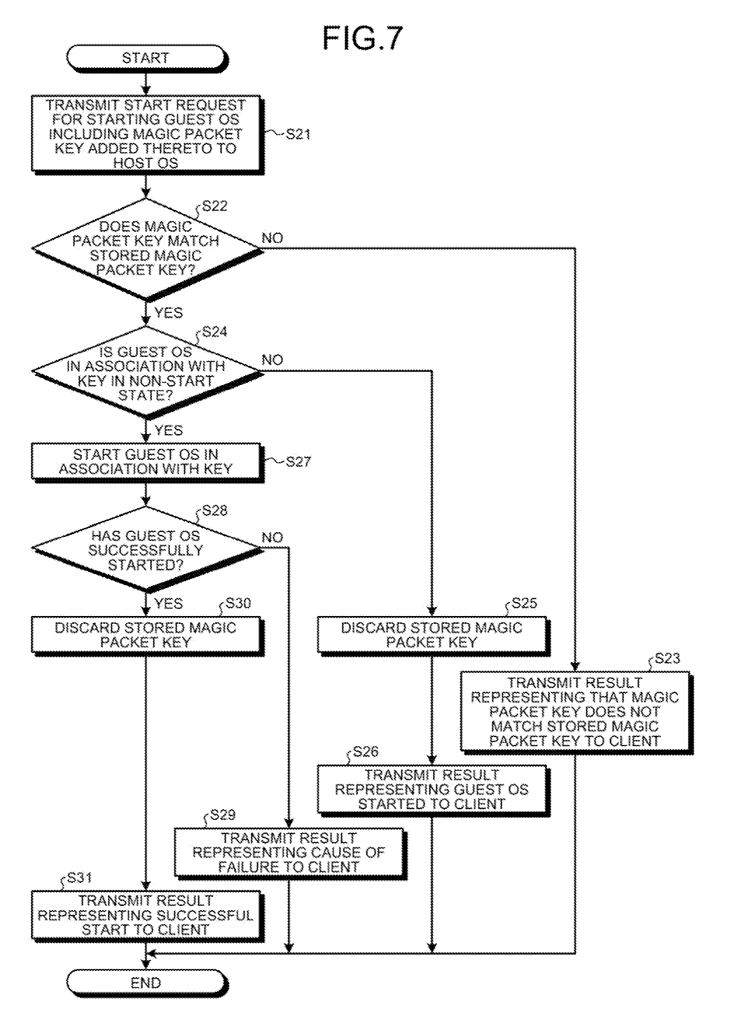

Next, a guest OS start process according to the second embodiment will be explained with reference to FIG. 7. FIG. 7 is a flowchart illustrating an operation of a guest OS start process. In the flowchart explained below, Step S21 is an operation performed by the client machine 3. Step S22 to Step S31 are operations performed by the host OS control unit 50. The operations will be explained in connection with an example in which the guest OS having the guest OS control unit 70-1 is started in the OFF state via the network.

First, in Step S21, the guest OS start requesting unit 83 of the client machine 3 transmits a start request including a magic packet key added thereto as a start request for starting the guest OS in the OFF state to the guest OS starting unit 52 via the network.

Subsequently, at Step S22, the start judging unit 52a of the host OS control unit 50 receives the start request for starting the guest OS from the guest OS start requesting unit 83 and extracts the magic packet key from the received start request. In Step S22, the start judging unit 52a judges whether or not the extracted magic packet key matches the magic packet key 61c stored in the magic packet key management storage unit 61. In Step S23, when it is determined that the extracted magic packet key does not match the magic packet key 61c stored in the magic packet key management storage unit 61 (No in Step S22), the start judging unit 52a transmits the start result representing that the magic packet key does not match the start request resource.

However, in Step S24, when it is determined that the magic packet key matches the magic packet key 61c stored in the magic packet key management storage unit 61 (Yes in Step S22), the start judging unit 52a judges whether or not the guest OS associated with the magic packet key is in a non-start state. In Step S25, when it is determined that the guest OS is not in the non-start state, that is, the guest OS already started (No in Step S24), the magic packet key discarding unit 53 judges the magic packet key as the “invalid key” and discards the magic packet key from the magic packet key management storage unit 61. In Step S26, the start judging unit 52a transmits the start result representing that the guest OS associated with the magic packet key started to the request source of the start request.

However, in Step S27, when it is determined that the guest OS is in the non-start state (Yes in Step S24), the starting unit 52b starts the guest OS associated with the magic packet key. Subsequently, in Step S28, the starting unit 52b judges whether or not the guest OS successfully started. In Step S29, when it is determined that the guest OS did not successfully start (No in Step S28), the start judging unit 52a transmits the start result representing the cause of the start failure of the guest OS to the request source of the start request.

However, in Step S30, when it is determined that the guest OS successfully started (Yes in Step S28), the magic packet key discarding unit 53 judges the magic packet key as the “invalid key” and discards the magic packet key from the magic packet key management storage unit 61. In Step S31, the starting unit 52b transmits the start result representing that the guest OS successfully started to the request source of the start request.

### Operation of Virtual Machine System According to Second Embodiment

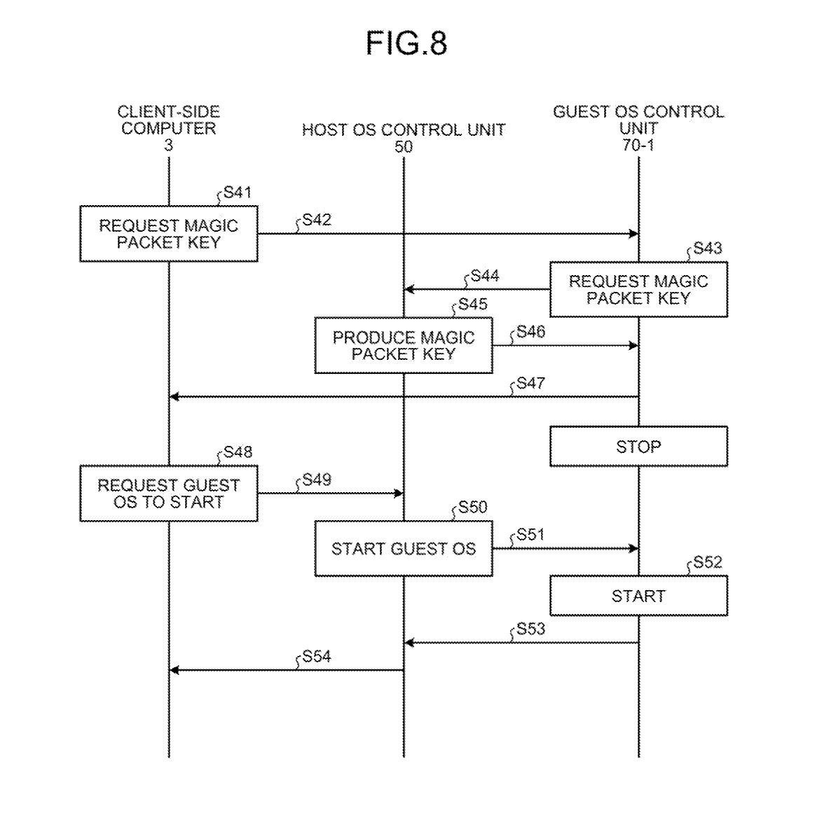

Next, an operation of the virtual machine system 9 according to the second embodiment will be explained in connection with data exchange. FIG. 8 is a sequence diagram illustrating a processing operation of the virtual machine system 9 according to the second embodiment. The operation will be explained in connection with an example in which the guest OS that drives the guest OS control unit 70-1 is started via the network.

In Step S41 and Step S42, the client machine 3 transmits the production request for the new magic packet key used for starting the guest OS to the guest OS control unit 70-1. In Step S43 and Step S44, the guest OS control unit 70-1 transmits the production request to the host OS control unit 50.

Subsequently, in Step S45, the host OS control unit 50 produces the new magic packet key for the guest OS. The host OS control unit 50 stores the produced magic packet key in the magic packet key management storage unit 61 in association with the guest OS that starts by using the magic packet key. In Step S46 and Step S47, the host OS control unit 50 transmits the produced new magic packet key to the client machine 3 through the guest OS control unit 70-1 of the request source. The client machine 3 stores the magic packet key in the magic packet key storing unit 82.

Thereafter, the guest OS that drives the guest OS control unit 70-1 stops. In this case, in Step S48 and Step S49, the client machine 3 transmits the start request for starting the guest OS in the OFF state using the magic packet key stored in the magic packet key storing unit 82 to the host OS control unit 50.

Subsequently, the host OS control unit 50 judges whether or not the magic packet key matches the magic packet key 61c stored in the magic packet key management storage unit 61. In Step S50, when the magic packet key matches the magic packet key 61c stored in the magic packet key management storage unit 61, the host OS control unit 50 starts the guest OS associated with the magic packet key. Here, let us assume that the magic packet key that matches is the magic packet key associated with the guest OS that drives the guest OS control unit 70-1. In this case, in Step S51 and Step S52, the host OS control unit 50 starts the guest OS associated with the magic packet key.

In Step S53, the host OS control unit 50 obtains the start result of the guest OS and, in Step S54, the host OS control unit 50 transmits the obtained start result to the client machine 3.

### Effects of Second Embodiment

According to the second embodiment, the host OS control unit 50 receives the production request for the new magic packet key used for starting the guest OS from the client machine via the network. The host OS control unit 50 produces the magic packet key and stores the produced magic packet key in the magic packet key management storage unit 61 in association with the guest OS that starts by using the magic packet key. The host OS control unit 50 receives the start request for starting the guest OS using the magic packet key from the client machine via the network when the guest OS is in the OFF state. The host OS control unit 50 compares the magic packet key with the magic packet key stored in the magic packet key management storage unit 61 and starts the guest OS for which the start request is made based on the comparison result.

According to such a configuration, the host OS control unit 50 produces the new magic packet key whenever the production request for the new magic packet key used for starting the guest OS is made and associates the new magic packet key produced by the latest production request with the guest OS. Therefore, the host OS control unit 50 can verity the validity of the magic packet key used when the start request is made through the latest new magic packet key associated with the guest OS when the start request of the guest OS using the magic packet key is made via the network. As a result, the host OS control unit 50 can surely prevent the illegal start of the guest OS and make the start of the guest OS secure. That is, even in the case in which the magic packet key used when the start of the guest OS is requested is leaked, the host OS control unit 50 can prevent the guest OS from being started using leaked magic packet key. The host OS control unit 50 starts the guest OS in the OFF state in response to the start request of the client machine 3 and thus can simply implement the WOL even though the WOL function is not mounted in the LAN card or the BIOS. In addition, since the host OS control unit 50 controls the start of the guest OS, compared to the case where the client machine 3 logs in the host OS and starts the guest OS, an operation mistake can be avoided, and security can be ensured.

Further, according to the second embodiment, the guest OS starting unit 52 starts the guest OS associated with the magic packet key using the magic packet key stored in the magic packet key management storage unit 61. In this case, the magic packet key discarding unit 53 discards the magic packet key from the magic packet key management storage unit 61. As a result, the host OS control unit 50 can ensure relatively firm security compared with the case of always using the same magic packet key.

Further, according to the second embodiment, the magic packet key discarding unit 53 discards the magic packet key from the magic packet key management storage unit 61 when the guest OS starting unit 52 starts the guest OS in a given number of times using the magic packet key. When an execution of an application that operates on the guest OS is finished, the guest OS is turned off. In this case, if the magic packet key discarding unit 53 discards the magic packet key used for the successful start of the guest OS after each success of the start, security can be further ensured.

Further, according to the second embodiment, the magic packet key discarding unit 53 discards the magic packet key from the magic packet key management storage unit 61 when the term of validity of the magic packet key associated with the guest OS expires. Therefore, the guest OS starting unit 52 can prevent the magic packet key stored in the client machine 3 from being used several times, and security can be ensured.

Furthermore, according to the second embodiment, the magic packet key producing unit 51 may produce the magic packet key in the same format as the MAC address. Therefore, since software having the existing WOL function can be diverted, a process for developing the guest OS start process can be considerably reduced.

### [c] Third Embodiment

The virtual machine system 9 according to the second embodiment has been explained in connection with the case in which a client machine 5 makes the start request for starting the guest OS with respect to the host OS control unit 50 via the network. The virtual machine system 9 is not limited thereto, and the client machine 5 may make the start request for starting the guest OS with respect to the host OS control unit 50 via the network and display the start result of the guest OS that started to operate in response to the start request.

Therefore, a third embodiment will be explained in connection with an example in which a virtual machine system 99 makes a start request of the guest OS with respect to the host OS control unit 50 via the network and displays the start result of the guest OS that started to operate in response to the start request.

### Structure of Virtual Machine According to Third Embodiment

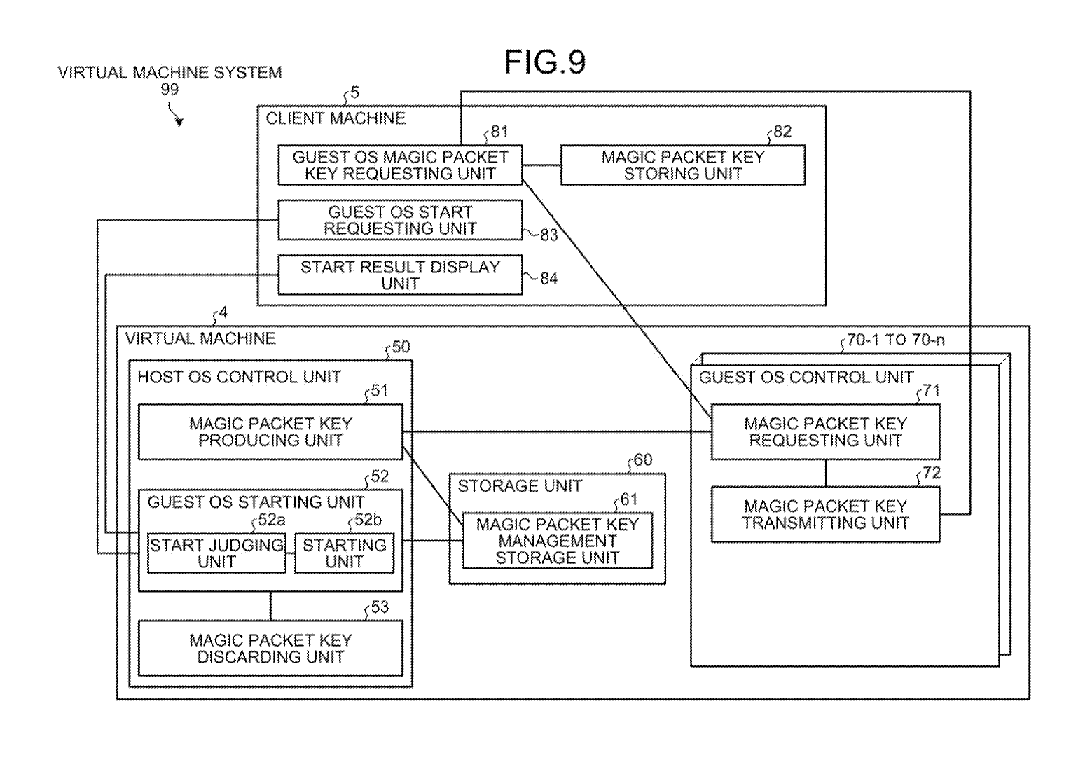

FIG. 9 is a functional block diagram illustrating a structure of the virtual machine system 99 using a virtual machine 4 according to a third embodiment. The same structure as in the virtual machine system 9 illustrated in FIG. 3 is denoted by the same symbol, so a description on the duplicated structure and operation will not be repeated. The third embodiment is different from the second embodiment in that a start result display unit 84 is added to the client machine 5.

The starting unit 52b of the host OS control unit 50 receives the start result on the start request of the guest OS from the guest OS and transmits the received start result to the start result display unit 84 of the client machine 5 that is the request source of the start request of the guest OS. For example, when the guest OS is a UNIX (a registered trademark), the starting unit 52b obtains a system call related to a power start or a return code of a library function from the guest OS that is requested to start. The starting unit 52b transmits the received return code to the client machine 5.

The start result display unit 84 of the client machine 5 outputs the start result of the guest OS transmitted from the starting unit 52b of the host OS control unit 50. Specifically, the start result display unit 84 displays information transmitted from the starting unit 52b, that is, the start result representing successful start of the guest OS or the start result representing the cause of start failure of the guest OS, for example, on a monitor. The cause in which the guest OS failed to start includes shortages of a memory capacity and a CPU. The start result display unit 84 may output the start result transmitted from the start judging unit 52a of the host OS control unit 50, that is, the start result representing that the magic packet key matches or that the guest OS successfully started.

### Operation of Magic Packet Key Producing Process According to Third Embodiment

Next, a magic packet key producing process according to the third embodiment is the same as in the second embodiment (FIG. 6), and thus a description thereof will not be repeated.

### Operation of Guest OS Start Process According to Third Embodiment

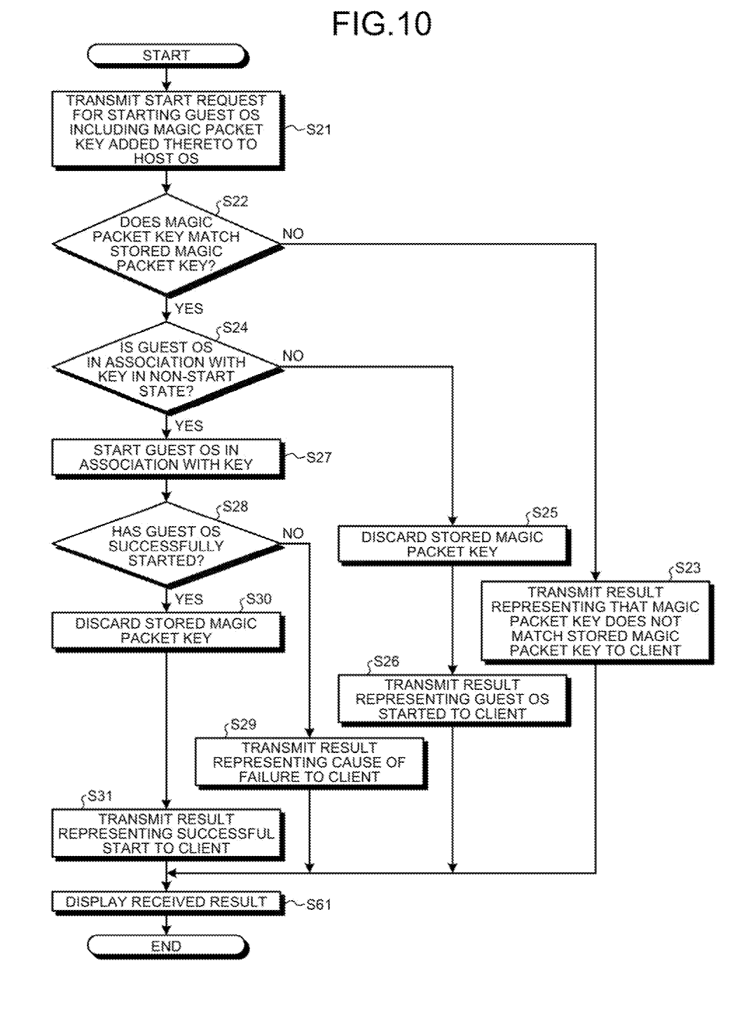

Next, the guest OS start process according to the third embodiment will be explained with reference to FIG. 10. FIG. 10 is a flowchart illustrating an operation of the guest OS start process according to the third embodiment. In the flowchart explained below, Step S21 and Step S61 are operations performed by the client machine 5. Step S22 to step S31 are operations performed by the host OS control unit 50. The operations will be explained in connection with an example in which the guest OS having the guest OS control unit 70-1 is started via the network. It is assumed that the magic packet key discarding unit 53 judges the magic packet key as the “invalid key” if the magic packet key is used once. Further, the same operation as in the flowchart illustrating the operation of the guest OS start process illustrated in FIG. 7 is denoted by the same reference numeral, and thus a description on the duplicated operation will not be repeated.

First, in Step S21, the guest OS start requesting unit 83 of the client machine 5 transmits the start request including the magic packet key added thereto as the start request for starting the guest OS in the OFF state to the guest OS starting unit 52 via the network. Subsequently, in Step S22, the start judging unit 52a of the host OS control unit 50 judges whether or not the received magic packet key matches the magic packet key 61c stored in the magic packet key management storage unit 61. In Step S23, when it is determined that the magic packet key does not match the magic packet key 61c stored in the magic packet key management storage unit 61 (No in step S22), the start judging unit 52a transmits the start result representing that the magic packet key does not match the request source of the start request.

However, in Step S24, when it is determined that the magic packet key matches the magic packet key 61c stored in the magic packet key management storage unit 61 (Yes in step S22), the start judging unit 52a judges whether or not the guest OS associated with the magic packet key is in the non-start state. In Step S25, when it is determined that the guest OS is not in the non-start state, that is, the guest OS already started (No in step S24), the magic packet key discarding unit 53 judges the magic packet key as the “invalid key” and discards the magic packet key from the magic packet key management storage unit 61. In Step S26, the start judging unit 52a transmits the start result representing that the guest OS started to the request source of the start request.

However, in Step S27, when it is determined that the guest OS is in the non-start state (Yes in step S24), the starting unit 52b starts the guest OS associated with the magic packet key. Subsequently, in Step S28, the starting unit 52b judges whether or not the guest OS successfully started. In Step S29, when it is determined that the guest OS did not successfully start (No in step S28), the starting unit 52b transmits the start request representing the cause the start failure of the guest OS to the request source of the start request. For example, when the host OS is a UNIX (a registered trademark), the starting unit 52b transmits a system call related to a power start or a return code of a library function to the request source of the start request.

However, in Step S30, when it is determined that the guest OS successfully started (Yes in step S28), the magic packet key discarding unit 53 judges the magic packet key as the “invalid key” and discards the magic packet key. In Step S31, the starting unit 52b transmits the start result representing that the guest OS successfully started to the request source of the start request.

In Step S61, the start result display unit 84 of the client machine 5 as the request source of the start request receives the start result of the guest OS from the start judging unit 52a or the starting unit 52b and displays the received start result, for example, on a monitor.

### Operation of Virtual Machine System According to Third Embodiment

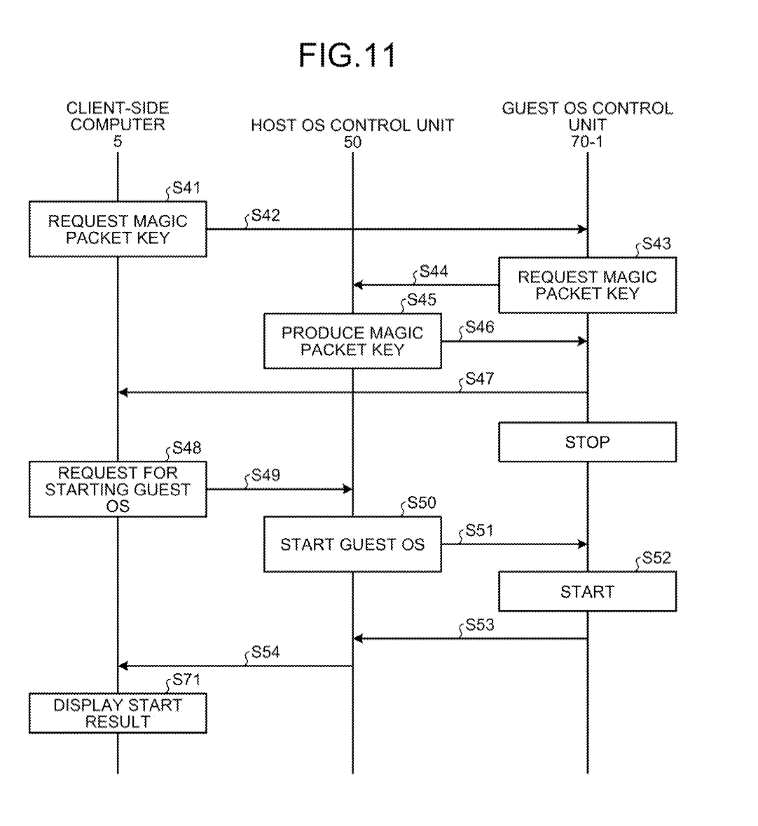

Next, an operation of the virtual machine system 99 according to the third embodiment will be explained in connection with data exchange. FIG. 11 is a sequence diagram illustrating a processing operation of the virtual machine system 99 according to the third embodiment. The operation will be explained in connection with an example in which the guest OS that drives the guest OS control unit 70-1 is started via the network. The same processing operation as in the sequence illustrating the processing operation of the virtual machine system illustrated in FIG. 8 is denoted by the same reference numeral, and thus a description on the duplicated operation will not be repeated.

In Step S41 and Step S42, the client machine 5 transmits the production request for the new magic packet key used for starting the guest OS to the guest OS control unit 70-1. In Step S43 and Step S44, the guest OS control unit 70-1 transmits the production request to the host OS control unit 50.

Subsequently, in Step S45, the host OS control unit 50 produces the new magic packet key for the guest OS. The host OS control unit 50 stores the produced magic packet key in the magic packet key management storage unit 61 in association with the guest OS that starts by using the magic packet key. In Step S46 and Step S47, the host OS control unit 50 transmits the new magic packet key to the client machine 5 through the guest OS control unit 70-1 of the request source. The client machine 5 stores the magic packet key in the magic packet key storing unit 82.

Thereafter, the guest OS that drives the guest OS control unit 70-1 is turned off. In this case, in Step S48 and Step S49, the client machine 5 transmits the start request for starting the guest OS in the OFF state using the magic packet key stored in the magic packet key storing unit 82 to the host OS control unit 50.

Subsequently, the host OS control unit 50 judges whether or not the magic packet key matches the magic packet key 61c stored in the magic packet key management storage unit 61. In Step S50, when the magic packet key matches the magic packet key 61c stored in the magic packet key management storage unit 61, the host OS control unit 50 starts the guest OS associated with the magic packet key. Here, it is assumed that the matched magic packet key is the magic packet key associated with the guest OS that drives the guest OS control unit 70-1. In this case, in Step S51 and Step S52, the host OS control unit 50 starts the guest OS associated with the magic packet key.

In Step S53, the host OS control unit 50 obtains the start result of the guest OS. In Step S54, the host OS control unit 50 transmits the obtained start result to the client machine 5. In Step S71, The client machine 5 displays the start result of the guest OS, for example, on a monitor.

### Effects of Third Embodiment

According to the third embodiment, the guest OS starting unit 52 of the host OS control unit 50 transmits the start result of the guest OS to the client machine 5 that is the request source of the start request of the guest OS, and the client machine 5 outputs the received start result. Therefore, since the client machine 5 can recognize the cause of the failure from the start result when the start result of the guest OS is a failure, it is possible to have the network administrator to take action against the cause of the failure at the remote site.

Others

The virtual machines 2 and 4 can be implemented by mounting respective functions of the host OS control unit 50, the magic packet key management storage unit 61, and the guest OS control units 70-1 to 70-n in an information processing apparatus such as a well-known PC or a well-known workstation.

The components illustrated in the drawings is not necessarily physically configured as illustrated in the drawings. That is, a specific aspect of division or integration of respective devices is not limited to ones illustrated in the drawings, and all or part thereof may be divided or integrated functionally or physically in arbitrary units according to a variety of loads or use states. For example, the guest OS starting unit 52 and the magic packet key discarding unit 53 may be integrated as a one part. Further, the magic packet key producing unit 51 may be divided into a producing unit for producing the magic packet key and a storing unit for storing the produced magic packet key in the magic packet key management storage unit 61. Further, the storage unit 60 may be connected via the network as an external device of the virtual machines 2 and 4.

Program

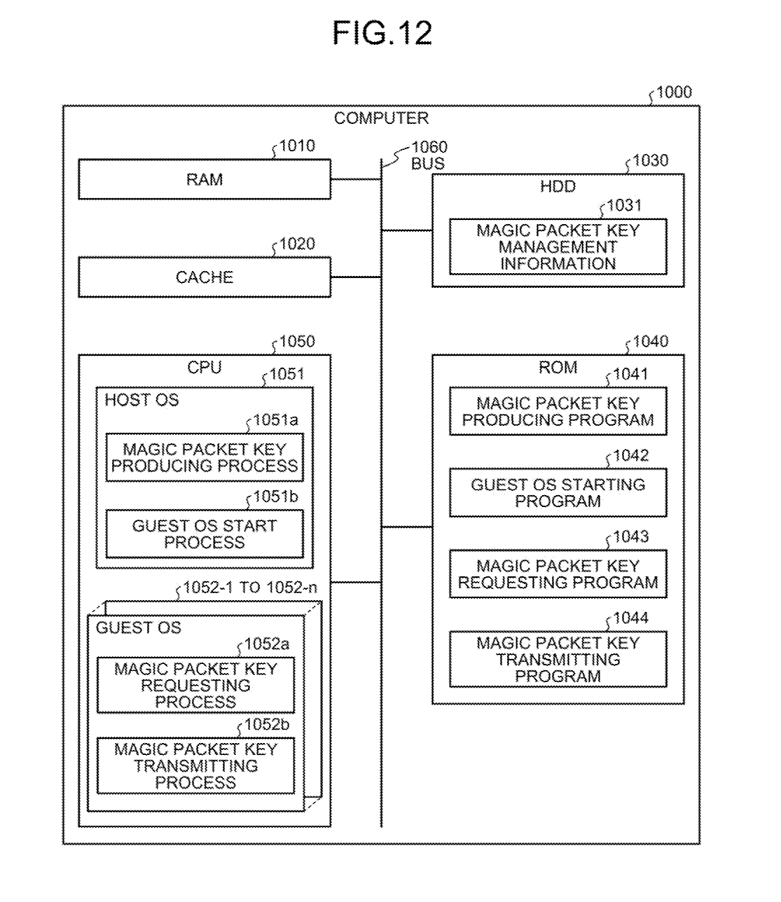

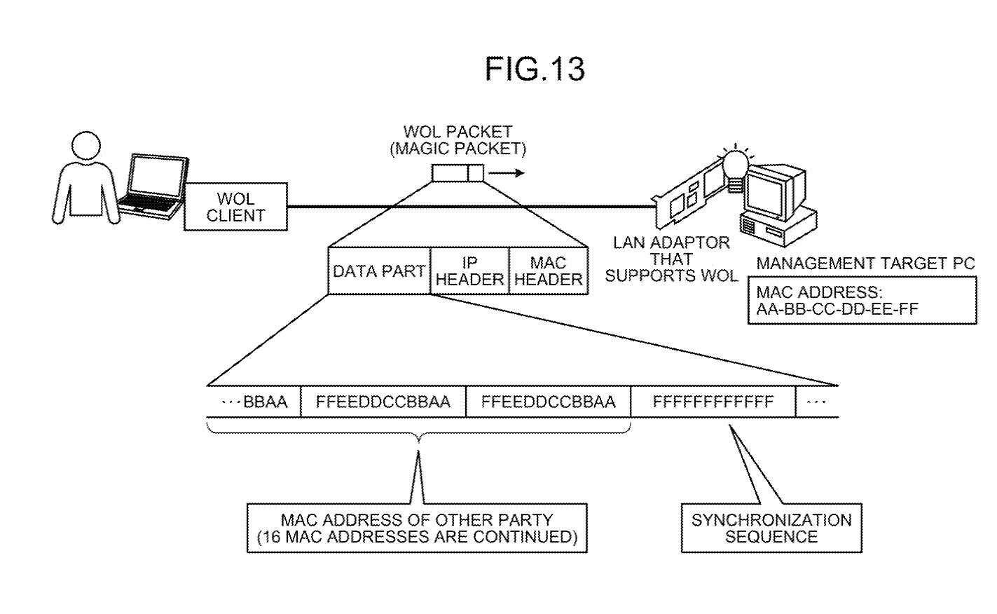

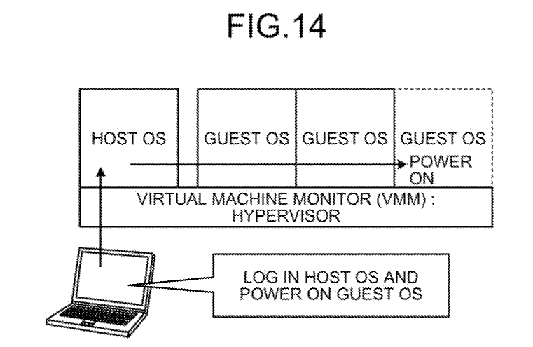

The processes explained in the embodiments may be implemented by executing a previously prepared program with a computer such as a PC or a workstation. An example of a computer that executes a remote start program having the same function as the virtual machine 2 illustrated in FIG. 3 will be explained below with reference to FIG. 12.

FIG. 12 is a view illustrating a computer that executes a remote start program. As illustrated in FIG. 12, a computer 1000 includes a random access memory (RAM) 1010, a cache 1020, a HDD 1030, a read only memory (ROM) 1040, a CPU 1050, and a bus 1060. The RAM 1010, the cache 1020, the HDD 1030, the ROM 1040, and the CPU 1050 are connected to one another through the bus 1060. The CPU 1050 includes a host OS 1051 and guest OSs 1052-1 to 1052-n.

The remote start program that performs the same function as the virtual machine 2 illustrated in FIG. 3 is stored in the ROM 1040 in advance. Specifically, a magic packet key producing program 1041, a guest OS starting program 1042, a magic packet key requesting program 1043, and a magic packet key transmitting program 1044 are stored in the ROM 1040.

The host OS 1051 of the CPU 1050 reads out and executes the magic packet key producing program 1041 and the guest OS starting program 1042. The guest OSs 1052-1 to 1052-n of the CPU 1050 reads out and executes the magic packet key requesting program 1043 and the magic packet key transmitting program 1044. As illustrated in FIG. 12, a magic packet key producing process 1051a is produced by executing the magic packet key producing program 1041, and a guest OS start process 1051b is produced by executing the guest OS starting program 1042. The magic packet key requesting program 1043 performs a magic packet key requesting process 1052a, and the magic packet key transmitting program 1044 performs a magic packet key transmitting process 1052b.

The magic packet key producing process 1051a corresponds to the magic packet key producing unit 51 illustrated in FIG. 3, and the guest OS start process 1051b corresponds to the guest OS starting unit 52 illustrated in FIG. 3. The magic packet key requesting process 1052a corresponds to the magic packet key requesting unit 71 illustrated in FIG. 3, and the magic packet key transmitting process 1052b corresponds to the magic packet key transmitting unit 72 illustrated in FIG. 3.

Magic packet key management information 1031 is stored in the HDD 1030 as illustrated in FIG. 12. For example, the magic packet key management information 1031 corresponds to a variety of data of the magic packet key management storage unit 61 stored in the storage unit 60 illustrated in FIG. 3.

The above described programs 1041 to 1044 do not need to be necessarily stored in the ROM 1040. For example, the programs 1041 to 1044 may be stored in a portable physical medium such as a flexible disk (FD), a CD-ROM, an MO disk, a DVD disk, an optical magnetic disk, and an IC card that are inserted into the computer 1000. The programs 1041 to 1044 may be stored in a fixed physical medium such as a HDD disposed outside or inside the computer 1000. The programs 1041 to 1044 may be stored in another computer (or sever) connected to the computer 1000 via a public line, a LAN, or a wide area network (WAN). The computer 1000 may read out and execute the programs, for example, from the above described flexible disk.

According to an aspect of a virtual machine of the present invention, there is an effect of being capable of surely preventing a guest OS included in a virtual machine from being illegally started through a network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A virtual machine, comprising:
an identification information producing unit that produces identification information when a production request for new identification information used for starting a guest operating system (OS) controlled by a host OS is received via a network;
an identification information storing unit that stores the identification information produced by the identification information producing unit in association with a guest OS that starts by using the identification information; and
a guest OS starting unit that, when a start request for starting the guest OS using the identification information is received via the network during an off state of the guest OS, compares the produced identification information with the identification information stored in the identification information storing unit and starts the guest OS for which the start request is made through the host OS based on the comparison result.

2. The virtual machine according to claim 1, further comprising an identification information discarding unit that discards the identification information from the identification information storing unit when the guest OS associated with the identification information started by using the identification information stored in the identification information storing unit.

3. The virtual machine according to claim 2, wherein the identification information discarding unit discards the identification information from the identification information storing unit when the guest OS started in a given number of times by the guest OS starting unit by using the identification information associated with the guest OS.

4. The virtual machine according to claim 2, wherein the identification information discarding unit discards the identification information from the identification information storing unit when the term of validity of the identification information associated with the guest OS expires.

5. The virtual machine according to claim 1, wherein the identification information producing unit produces the identification information in the same format as a media access control (MAC) address.

6. The virtual machine according to claim 1, wherein the guest OS starting unit transmits a result of the start of the guest OS to a request source of a start request of the guest OS.

7. A computer-readable, non-transitory medium storing a remote start program causing a computer to execute a process comprising:
producing identification information when a production request for new identification information used for starting a guest operating system (OS) controlled by a host OS is received via a network;
storing the identification information in association with a guest OS that starts by using the identification information; and
comparing, when a start request for starting the guest OS using the identification information is received via the network during an off state of the guest OS, the produced identification information with the identification information stored at the storing and starting the guest OS for which the start request is made through the host OS based on the comparison result.

8. A remote start method comprising:
producing identification information when a production request for new identification information used for starting a guest operating system (OS) controlled by a host OS is received via a network;
storing the identification information in association with a guest OS that starts by using the identification information; and
comparing, when a start request for starting the guest OS using the identification information is received via the network during an off state of the guest OS, the produced identification information with the identification information stored at the storing and starting the guest OS for which the start request is made through the host OS based on the comparison result.

9. A virtual machine system, comprising:
a virtual machine including a host operating system (OS) and a guest OS controlled by the host OS; and
a remote computer connected to the virtual machine via a network,
wherein the virtual machine include
an identification information producing unit that produces identification information when a production request of new identification information used for starting the guest OS is obtained from the remote computer via a network;
an identification information storing unit that stores the identification information produced by the identification information producing unit in association with the guest OS that starts by using the identification information; and
a guest OS starting unit that, when a start request for starting the guest OS using the identification information is obtained from the remote computer via the network during an off state of the guest OS, compares the obtained identification information with the identification information stored in the identification information storing unit and starts the guest OS for which the start request is made through the host OS based on the comparison result.

10. The virtual machine system according to claim 9, wherein the guest OS starting unit transmits a result of the start of the guest OS to the remote computer that is a request source of a start request of the guest OS, and the remote computer comprises a start result output unit that outputs the result of the start of the guest OS transmitted from the guest OS starting unit on an output unit.
